(19) United States
(12) Patent Application Publication
(10) Pub. No.: US 2025/0304451 A1
(43) Pub. Date: Oct. 2, 2025

(54) METHOD FOR PRODUCING SILICA SOL AND SILICA SOL

(71) Applicant: FUJIMI INCORPORATED, Kiyosu-shi (JP)

(72) Inventors: Yusuke Kawasaki, Kiyosu-shi (JP); Masaaki Ito, Kiyosu-shi (JP); Shogo Tsubota, Kiyosu-shi (JP); Keiji Ashitaka, Kiyosu-shi (JP)

(73) Assignee: FUJIMI INCORPORATED, Kiyosu-shi (JP)

(21) Appl. No.: 19/092,536

(22) Filed: Mar. 27, 2025

(30) Foreign Application Priority Data
Mar. 29, 2024 (JP) 2024-055421

(51) Int. Cl. C01B 33/146; C01B 33/145

(52) U.S. Cl. CPC C01B 33/146; C01B 33/145; C01P 2004/54; C01P 2004/64

(57) ABSTRACT

Provided is a method for producing a silica sol capable of increasing the ratio of heteromorphized silica particles. A method for producing a silica sol according to an aspect of the present disclosure includes a step of preparing a first liquid including silica core particles having an average value of longest diameters of primary particles of 20 nm or less, and a step of preparing a second liquid including linked silica core particles by holding the first liquid for 72 hours or longer.

### BACKGROUND

### 1. Technical Field

The present disclosure relates to a method for producing a silica sol and a silica sol.

### 2. Description of Related Arts

Conventionally, chemical mechanical polishing (CMP) using a polishing composition has been performed on the surface of materials such as metals, semimetals, nonmetals, and their oxides. It is known that such polishing composition generally has a configuration in which an aqueous solution having a chemical polishing action and particles (abrasive grains) having a mechanical polishing action are mixed and dispersed, and a silica sol is used as the abrasive grains. In such a case, by heteromorphizing silica particles, high friction can be obtained during polishing, and the polishing rate can be further improved.

JP 2018-168031 A discloses, as a method for heteromorphizing silica particles, a method for producing a silica sol, including mixing a liquid (A) containing an alkaline catalyst, water, a first organic solvent, and silica particles for association with a liquid (B) containing at least one of tetramethoxysilane and a condensate thereof and a second organic solvent to prepare a reaction liquid, in which during the mixing, an addition rate of the liquid (B) is 8.5×10⁻⁴ to 5.6×10⁻³ mol/min in terms of silicon atoms with respect to 1 mol of the water contained in the liquid (A).

### SUMMARY

In the technique described in JP 2018-168031 A, a silica sol including highly associated silica particles can be obtained. However, for example, when it is intended to eliminate the surface roughness of a wafer, it is required to increase the ratio of heteromorphized silica particles included in the silica sol.

Therefore, the present disclosure has been made in view of the above circumstances, and an object thereof is to provide a method for producing a silica sol capable of increasing the ratio of heteromorphized silica particles.

The present inventors have conducted intensive studies in view of the above circumstances. As a result, the present inventors have found that the above effect can be obtained by a method for producing a silica sol, including preparing a first liquid including silica core particles having an average value of longest diameters of primary particles of 20 nm or less, and preparing a second liquid including linked silica core particles by holding the first liquid for 72 hours or longer, thereby completing the present disclosure.

### BRIEF DESCRIPTION OF THE DRAWING

FIG. 1 is a view for explaining a method for measuring a longest diameter of primary particles of silica core particles.

### DETAILED DESCRIPTION

Hereinafter, embodiments according to an aspect of the present disclosure will be described. The present disclosure is not limited only to the following embodiments, and various modifications can be made within the scope of claims. The embodiments described in the present specification may be other embodiments by being arbitrarily combined.

In the present specification, the phrase “X to Y” indicating a range means “X or more and Y or less”. Unless otherwise specified, operations and measurements of physical properties and the like are measured under the conditions of room temperature (20 to 25° C.)/relative humidity of 40 to 50% RH.

### <Method for Producing Silica Sol>

An aspect of the present disclosure relates to a method for producing a silica sol, including preparing a first liquid including silica core particles having an average value of longest diameters of primary particles of 20 nm or less, and preparing a second liquid including linked silica core particles by holding the first liquid for 72 hours or longer. With such a configuration, a silica sol including a large amount of heteromorphized silica particles is provided. According to an aspect of the present disclosure, there is provided a method for producing a silica sol capable of increasing the ratio of heteromorphized silica particles.

In the present disclosure, the silica sol including heteromorphized silica particles means that the silica particles in the silica sol satisfy any one of an average aspect ratio of 1.5 or more and an average circularity of 0.80 or less. The silica particles in the silica sol according to the present aspect preferably satisfy an average aspect ratio of 1.5 or more and an average circularity of 0.80 or less, and more preferably satisfy an average aspect ratio of 1.5 or more, an average circularity of 0.80 or less, and an average association degree of 1.7 or more. The average association degree, the average aspect ratio, and the average circularity will be described in the silica sol described later.

The reason why the above effect is achieved by the production method according to the present aspect is not necessarily clear, but it is considered as follows.

In the method for producing a silica sol according to the present aspect, it is considered that the surface of the silica core particles included in the first liquid is activated because the amount of hydroxyl groups is large. Therefore, the present inventors have considered that it is possible to obtain silica particles in which silica core particles are bonded to each other to be heteromorphized by a condensation reaction between hydroxyl groups on the surfaces of silica core particles and hydroxyl groups on the surfaces of other silica particles. As a result of studies by the present inventors, it has been found that the silica core particles may be bonded to each other by holding the first liquid for a long time (72 hours or longer). The present inventors have found that when the average value of longest diameters of primary particles of silica core particles exceeds a certain value (20 nm), heteromorphized silica particles cannot be obtained even if the first liquid is held for a long time. Based on these findings, the present inventors have completed the present disclosure.

The above mechanism is based on speculation, and its correctness does not affect the technical scope of the present disclosure.

Hereinafter, constituent requirements of the method for producing a silica sol according to the present aspect will be described.

### (Silica Core Particle Preparation Step (Step of Preparing Silica Core Particles))

In the silica core particle preparation step, a first liquid including silica core particles having an average value of longest diameters of primary particles of 20 nm or less is prepared.

In the present specification, the silica core particles included in the first liquid include silica particles in which two or more primary particles are bonded.

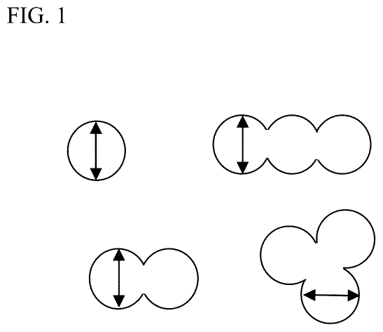

In the present specification, the average value of longest diameters of primary particles of silica core particles means a value obtained by measuring the longest diameters of primary particles of each of silica core particles in a captured scanning electron microscope (SEM) image as exemplified by double-headed arrows in FIG. 1, and calculating the average value of longest diameters of primary particles of all the silica core particles in the SEM image. As the average value of longest diameters of primary particles, a value calculated by the method described in Examples is adopted.

In the present specification, the average value of longest diameters of primary particles of the silica core particles is also simply referred to as “the average longest diameter of the silica core particles”.

The first liquid according to the present aspect includes silica core particles having an average value of longest diameters of primary particles of 20 nm or less. When the average value of longest diameters of primary particles of the silica core particles exceeds 20 nm, heteromorphized silica particles cannot be obtained in the bonding step described later (see Comparative Example 4). The upper limit of the average longest diameter of the silica core particles is preferably 18 nm or less. The lower limit of the average longest diameter of the silica core particles is not particularly limited, and is, for example, 2 nm or more, preferably 5 nm or more, and more preferably 10 nm or more. The average longest diameter of the silica core particles is preferably 2 nm or more and 20 nm or less, more preferably 5 nm or more and 20 nm or less, still more preferably 10 nm or more and 20 nm or less, and particularly preferably 10 nm or more and 18 nm or less.

In the silica core particle preparation step, the method for preparing the first liquid is not particularly limited, and a conventionally known method can be used. For example, alkoxysilane or a condensate thereof can be reacted in an organic solvent containing water and an alkaline catalyst to obtain a first liquid including silica core particles.

Hereinafter, an embodiment of the silica core particle preparation step will be described.

In an embodiment, the silica core particle preparation step includes adding and mixing a liquid (B1) containing at least one of alkoxysilane and a condensate thereof and a second organic solvent or the liquid (B1) and a liquid (C1) containing water and being free of an alkaline catalyst in a liquid (A) containing an alkaline catalyst, water, and a first organic solvent and terminating the addition to prepare the first liquid when the average value of longest diameters of primary particles of the silica core particles is 20 nm or less.

The liquid (A) according to the present embodiment contains an alkaline catalyst, water, and a first organic solvent. The liquid (A) can contain other components in addition to the alkaline catalyst, water, and the first organic solvent as long as the effects of the present disclosure are not impaired.

In a preferred embodiment, the liquid (A) consists of an alkaline catalyst, water, and a first organic solvent. When the liquid (A) consists of an alkaline catalyst, water, and a first organic solvent, impurities contained in the first liquid can be reduced as much as possible. As a result, when the silica sol obtained by the production method of the present disclosure is used for a polishing slurry, it is possible to suppress the influence of impurities on polishing. It can be used also for the use applications in an object to be polished in which metal impurities are disliked, such as silicon wafers and device wafers, and a polishing slurry which is applicable widely can be provided.

As the alkaline catalyst contained in the liquid (A), a conventionally known alkaline catalyst can be used. From the viewpoint that contamination of metal impurities and the like can be minimized, examples of the alkaline catalyst include ammonia, ammonium salts such as tetramethylammonium hydroxide, ethylene diamine, diethylene triamine, triethylene tetramine, urea, monoethanolamine, diethanolamine, triethanolamine, and tetramethylquanidine. Among these, from the viewpoint of excellent catalytic action, ammonia, and ammonium salts such as tetramethylammonium hydroxide are more preferable, and ammonia is still more preferable. Since ammonia has high volatility, ammonia can be easily removed in the process of producing a silica sol. Note that, the alkaline catalyst may be used singly or as a mixture of two or more kinds thereof. The alkaline catalyst may be in the form of an aqueous solution.

As the water contained in the liquid (A), pure water or ultrapure water is preferably used from the viewpoint of minimizing contamination of metal impurities and the like. When the alkaline catalyst is in the form of an aqueous solution, water to be contained therein is water contained in the liquid (A). Therefore, the water contained in the aqueous solution of the alkaline catalyst is also preferably pure water or ultrapure water.

As the first organic solvent contained in the liquid (A), a hydrophilic organic solvent is preferably used, and specific examples thereof include alcohols such as methanol, ethanol, n-propanol, isopropanol, ethylene glycol, propylene glycol, and 1,4-butanediol; and ketones such as acetone and methyl ethyl ketone. The first organic solvent may be used singly or as a mixture of two or more kinds thereof.

As the first organic solvent according to the present embodiment, alcohols are preferable. By using alcohols, there is an effect that alcohols and water can be easily substituted by heating distillation when a water substitution step described later is performed. From the viewpoint of recovery and reuse of the organic solvent, it is preferable to use the same kind of alcohol as the alcohol generated by hydrolysis of alkoxysilane.

Among the alcohols, at least one of methanol, ethanol, isopropanol, and the like is more preferable. When tetramethoxysilane is used as alkoxysilane, the first organic solvent is preferably methanol.

The contents of the alkaline catalyst, water, and the first organic solvent in the liquid (A) are not particularly limited, and can be appropriately adjusted in order to set the average longest diameter of the silica core particles to a desired value.

The lower limit of the content of the alkaline catalyst (for example, ammonia) in the liquid (A) is, for example, 0.1 mass % or more and preferably 0.3 mass % or more with respect to the total amount (100 mass %) of the liquid (A) from the viewpoint of the action as a hydrolysis catalyst or the growth of silica particles. The lower limit of the content of the alkaline catalyst (for example, ammonia) may be 0.5 mass % or more, 1.0 mass % or more, or 2.0 mass % or more with respect to the total amount (100 mass %) of the liquid (A). The upper limit of the content of the alkaline catalyst (for example, ammonia) is not particularly limited. The upper limit of the content of the alkaline catalyst (for example, ammonia) is preferably 50 mass % or less with respect to the total amount (100 mass %) of the liquid (A) from the viewpoint of productivity and cost. The upper limit of the content of the alkaline catalyst (for example, ammonia) may be 40 mass % or less, 20 mass % or less, 15 mass % or less, or 10 mass % or less with respect to the total amount (100 mass %) of the liquid (A). The content of the alkaline catalyst (for example, ammonia) may be 0.1 mass % or more and 50 mass % or less, 0.3 mass % or more and 40 mass % or less, 0.5 mass % or more and 20 mass % or less, 1.0 mass % or more and 15 mass % or less, or 2.0 mass % or more and 10 mass % or less with respect to the total amount (100 mass %) of the liquid (A).

The content of water in the liquid (A) is adjusted in accordance with the amount of alkoxysilane or a condensate thereof used in the reaction. The lower limit of the content of water is preferably 5 mass % or more with respect to the total amount (100 mass %) of the liquid (A) from the viewpoint of hydrolysis of alkoxysilane. The upper limit of the content of water is preferably 50 mass % or less and more preferably 40 mass % or less with respect to the total amount (100 mass %) of the liquid (A) from the viewpoint of compatibility with the liquid (B1). The upper limit of the content of water may be 20 mass % or less with respect to the total amount (100 mass %) of the liquid (A). The content of water may be 5 mass % or more and 50 mass % or less, 5 mass % or more and 40 mass % or less, or 5 mass % or more and 20 mass % or less with respect to the total amount (100 mass %) of the liquid (A).

The lower limit of the content of the first organic solvent (for example, methanol) in the liquid (A) is preferably 10 mass % or more and more preferably 20 mass % or more with respect to the total amount (100 mass %) of the liquid (A) from the viewpoint of compatibility with the liquid (B1). The lower limit of the content of the first organic solvent (for example, methanol) may be 50 mass % or more or 75 mass % or more with respect to the total amount (100 mass %) of the liquid (A). The upper limit of the content of the first organic solvent (for example, methanol) is preferably 98 mass % or less and more preferably 95 mass % or less with respect to the total amount (100 mass %) of the liquid (A) from the viewpoint of dispersibility. The upper limit of the content of the first organic solvent (for example, methanol) may be 90 mass % or less or 85 mass % or less with respect to the total amount (100 mass %) of the liquid (A). The content of the first organic solvent (for example, methanol) may be 10 mass % or more and 98 mass % or less, 20 mass % or more and 95 mass % or less, 50 mass % or more and 90 mass % or less, or 75 mass % or more and 85 mass % or less with respect to the total amount (100 mass %) of the liquid (A).

The method for producing the liquid (A) is not particularly limited, and for example, a method of stirring and mixing an alkaline catalyst, water, the first organic solvent, and other components as necessary can be used.

The liquid (B1) according to the present embodiment contains at least one of alkoxysilane and a condensate thereof and a second organic solvent. The liquid (B1) can contain other components in addition to at least one of alkoxysilane and a condensate thereof and the second organic solvent as long as the effects of the present disclosure are not impaired.

In the present specification, “at least one of alkoxysilane and a condensate thereof” is also collectively referred to simply as “alkoxysilane and the like”.

In a preferred embodiment, the liquid (B1) consists of at least one of alkoxysilane and a condensate thereof and a second organic solvent. When the liquid (B1) consists of at least one of alkoxysilane and a condensate thereof and a second organic solvent, impurities contained in the first liquid can be reduced as much as possible. As a result, when the silica sol obtained by the production method of the present disclosure is used for a polishing slurry, it is possible to suppress the influence of impurities on polishing. It can be used also for the use applications in an object to be polished in which metal impurities are disliked, such as silicon wafers and device wafers, and a polishing slurry which is applicable widely can be provided.

Examples of alkoxysilane or a condensate thereof contained in the liquid (B1) include tetramethoxysilane, tetraethoxysilane, tetrapropoxysilane, and condensates thereof. These may be used singly or in combination of two or more kinds thereof. Among them, tetramethoxysilane is preferable from the viewpoint of having appropriate hydrolysis reactivity.

As the second organic solvent contained in the liquid (B1), a hydrophilic organic solvent is preferably used, and specific examples thereof include alcohols such as methanol, ethanol, n-propanol, isopropanol, ethylene glycol, propylene glycol, and 1,4-butanediol; and ketones such as acetone and methyl ethyl ketone.

As the second organic solvent according to the present embodiment, alcohols are preferable. By using alcohols, there is an effect that alcohols and water can be easily substituted by heating distillation when a water substitution step described later is performed. From the viewpoint of recovery and reuse of the organic solvent, it is preferable to use the same kind of alcohol as the alcohol generated by hydrolysis of alkoxysilane.

Among the alcohols, at least one of methanol, ethanol, isopropanol, and the like is more preferable. When tetramethoxysilane is used as alkoxysilane, the second organic solvent is preferably methanol.

The contents of the alkoxysilane and the like and the second organic solvent in the liquid (B1) are not particularly limited, and can be appropriately adjusted in order to set the average longest diameter of the silica core particles to a desired value.

The lower limit of the content of alkoxysilane and the like (for example, tetramethoxysilane and the like) in the liquid (B1) is preferably 50 mass % or more, more preferably 60 mass % or more, still more preferably 70 mass % or more, and particularly preferably 75 mass % or more. The upper limit of the content of alkoxysilane and the like (for example, tetramethoxysilane and the like) is preferably 98 mass % or less, more preferably 95 mass % or less, still more preferably 90 mass % or less, and particularly preferably 85 mass % or less. The content of alkoxysilane and the like (for example, tetramethoxysilane and the like) is preferably 50 mass % or more and 98 mass % or less, more preferably 60 mass % or more and 95 mass % or less, still more preferably 70 mass % or more and 90 mass % or less, and particularly preferably 75 mass % or more and 85 mass % or less.

The lower limit of the content of the second organic solvent (for example, methanol) in the liquid (B1) is preferably 2 mass % or more, more preferably 5 mass % or more, still more preferably 10 mass % or more, and particularly preferably 15 mass % or more. The upper limit of the content of the second organic solvent (for example, methanol) is preferably 50 mass % or less, more preferably 40 mass % or less, still more preferably 30 mass % or less, and particularly preferably 25 mass % or less. The content of the second organic solvent (for example, methanol) is preferably 2 mass % or more and 50 mass % or less, more preferably 5 mass % or more and 40 mass % or less, still more preferably 10 mass % or more and 30 mass % or less, and particularly preferably 15 mass % or more and 25 mass % or less.

When the contents of the alkoxysilane and the like and the second organic solvent in the liquid (B1) are in the above ranges, miscibility when mixed with the liquid (A) can be improved.

The alkoxysilane condensate in the liquid (B1) is, for example, a di- to dodecamer, and preferably a tetra- to octamer.

The method for producing the liquid (B1) is not particularly limited. From the viewpoint of miscibility, the method for producing the liquid (B1) preferably uses a method in which alkoxysilane and the like and, if necessary, other components are stirred and mixed in the second organic solvent.

The liquid (C1) according to the present embodiment contains water and being free of an alkaline catalyst. Since the liquid (C1) does not contain an alkaline catalyst, it is possible to suppress a local increase in the concentration of the alkaline catalyst at the time of mixing. The liquid (C1) can contain other components in addition to the alkaline catalyst as long as the effects of the present disclosure are not impaired.

In a preferred embodiment, the liquid (C1) consists of water. When the liquid (C1) consists of water, impurities contained in the first liquid can be reduced as much as possible. As a result, when the silica sol obtained by the production method of the present disclosure is used for a polishing slurry, it is possible to suppress the influence of impurities on polishing. It can be used also for the use applications in an object to be polished in which metal impurities are disliked, such as silicon wafers and device wafers, and a polishing slurry which is applicable widely can be provided.

As the water contained in the liquid (C1), pure water or ultrapure water is preferably used from the viewpoint of minimizing contamination of metal impurities and the like.

The content of water in the liquid (C1) is preferably 95 mass % or more, more preferably 98 mass % or more, still more preferably 99 mass % or more, and particularly preferably 100 mass %.

In the present embodiment, the liquid (B1) or the liquid (B1) and the liquid (C1) are added to and mixed with the liquid (A). When the liquid (B1) is mixed with the liquid (A), alkoxysilane and the like are hydrolyzed and polycondensated to produce silica core particles. The addition of the liquid (B1) or the liquid (B1) and the liquid (C1) is terminated when the average longest diameter of the silica core particles is 20 nm or less. As a result, the growth of the silica core particles can be stopped to prepare the first liquid. In the silica core particle preparation step, the addition of the liquid (B1) or the addition of the liquid (B1) and the liquid (C1) may be temporarily stopped in order to measure the average longest diameter of the silica core particles.

When the liquid (B1) or the liquid (B1) and the liquid (C1) are added to and mixed with the liquid (A), it is preferable to stir the liquid (A). The stirring speed is not particularly limited, and is, for example, 30 to 500 rpm.

The addition method of the liquid (B1) when the liquid (B1) is added to and mixed with the liquid (A) is not particularly limited, and either continuous addition or divided addition (for example, dropping) can be employed.

The addition rate of the liquid (B1) when the liquid (B1) is added to and mixed with the liquid (A) is not particularly limited, and can be appropriately adjusted within a range in which a gel-like material is not generated. For example, the addition rate of the liquid (B1) may be 8.5×10⁻⁴ mol/min or more and 5.6×10⁻³ mol/min or less in terms of silicon atoms with respect to 1 mol of water contained in the liquid (A). The term “in terms of silicon atoms” means that the number of moles of the silicon atoms contained in alkoxysilane and a condensate thereof is defined as the number of moles of alkoxysilane and a condensate thereof. For example, when alkoxysilane is tetramethoxysilane, 1 mol of tetramethoxysilane is 1 mol in terms of silicon atoms. When the condensate of tetramethoxysilane is a tetramer, 1 mol of the condensate corresponds to 4 mol in terms of silicon atoms.

The addition method of the liquid (B1) and the liquid (C1) when the liquid (B1) and the liquid (C1) are added to and mixed with the liquid (A) is not particularly limited. Almost constant amount of each of the liquid (B1) and the liquid (C1) may be added to the liquid (A) simultaneously, or the liquid (B1) and the liquid (C1) may be added to the liquid (A) alternately. The liquid (B1) and the liquid (C1) may be added at random. Among the above-described methods, from the viewpoint of suppressing a change in amount of water used for a synthesis reaction, a method of simultaneously adding the liquid (B1) and the liquid (C1) is preferably used, and a method of simultaneously adding almost constant amount of each of the liquid (B1) and the liquid (C1) is more preferably used.

As the addition method of the liquid (B1) and the liquid (C1) to the liquid (A), a method of separately adding (for example, dropping) the liquid (B1) and the liquid (C1) to the liquid (A) or a method of continuously adding the liquid (B1) and the liquid (C1) to the liquid (A) is preferably used from the viewpoint that local increase in concentration of an alkaline catalyst can be suppressed.

The addition rates of the liquid (B1) and the liquid (C1) when the liquid (B1) and the liquid (C1) are added to and mixed with the liquid (A) are not particularly limited, and can be appropriately adjusted within a range in which a gel-like material is not generated. The addition rate of the liquid (B1) can be set to the same addition rate as described above. The addition rate of the liquid (C1) is, for example, 1 mol/min or more and 3 mol/min or less, preferably 2 mol/min, in terms of water with respect to 1 mol (in terms of silicon atoms) of alkoxysilane and a condensate thereof to be charged in the liquid (B1).

The temperatures of the liquid (A), the liquid (B1), and the liquid (C1) when the first liquid is prepared are not particularly limited, and are, for example, 5° C. or higher and 100° C. or lower, and preferably 5° C. or higher and 70° C. or lower. The temperatures of the liquid (A), the liquid (B1), the liquid (C1), and the first liquid in the middle of preparation are preferably the same.

The preparation of the first liquid can also be performed under any of pressure conditions of reduced pressure, atmospheric pressure, and increased pressure. However, from the viewpoint of production cost, performance under atmospheric pressure is preferable.

As described above, the first liquid can be prepared.

### (Bonding Step (Step of Preparing Second Liquid))

In the bonding step, a second liquid including linked silica core particles is prepared by holding the first liquid for 72 hours or longer.

In the present specification, the “linked silica core particles” mean silica particles in which two or more primary particles, preferably three or more primary particles, are bonded.

In the present specification, holding means maintaining the first liquid in a stirred state or a standing state. The holding may be performed directly in the same device after the first liquid is prepared, or may be performed after the first liquid is moved to another device. The holding is preferably performed as it is in the same device after preparing the first liquid.

In the present specification, “holding the first liquid for 72 hours or longer” means holding the first liquid for 72 hours or longer after completion of preparation of the first liquid, and more specifically, holding the first liquid for 72 hours or longer after completion of addition of the liquid (B1) or the liquid (B1) and the liquid (C1) described above.

The lower limit of the time for holding the first liquid is not particularly limited as long as it is 72 hours or longer. The lower limit of the time for holding the first liquid may be 100 hours or longer or 120 hours or longer. The upper limit of the time for holding the first liquid is preferably 200 hours or shorter from the viewpoint that aggregation of particles can be suppressed. The upper limit of the time for holding the first liquid may be 170 hours or shorter or 150 hours or shorter. The time for holding the first liquid may be 72 hours or longer and 200 hours or shorter, 100 hours or longer and 170 hours or shorter, or 120 hours or longer and 150 hours or shorter.

In the case of holding the first liquid, the first liquid may be stirred, may be left to stand still, or may be stirred and left to stand still in combination. The stirring speed is not particularly limited, and is, for example, 30 to 500 rpm.

The temperature at which the first liquid is held is not particularly limited, and is, for example, 5° C. or higher and 100° C. or lower, preferably 5° C. or higher and 70° C. or lower, and more preferably 5° C. or higher and 60° C. or lower. The temperature at which the first liquid is held may be constant or may vary.

The holding of the first liquid can also be performed under any of pressure conditions of reduced pressure, atmospheric pressure, and increased pressure. However, from the viewpoint of production cost, performance under atmospheric pressure is preferable.

As described above, the second liquid can be prepared.

In the production method according to the present aspect, the prepared second liquid can be used as a silica sol as it is. A liquid obtained after subjecting the prepared second liquid to a growth step, a post-processing step, and the like described later may be used as a silica sol. In a preferred embodiment, from the viewpoint that aggregation of silica particles can be suppressed, a water substitution step of substituting an organic solvent present in the second liquid with water is performed.

### (Growth Step (Step of Preparing Third Liquid))

The method for producing a silica sol according to the present aspect can further include a growth step of preparing a third liquid including the grown linked silica core particles by adding and mixing a liquid (B2) containing at least one of alkoxysilane and a condensate thereof and a third organic solvent or the liquid (B2) and a liquid (C2) containing water and being free of an alkaline catalyst to the second liquid, after the preparing the first liquid.

In the present specification, the term “grown linked silica core particles” means that at least one of values of the average primary particle size and the average secondary particle size of the grown linked silica core particles included in the third liquid is larger than that of the linked silica core particles included in the second liquid.

The liquid (B2) contains at least one of alkoxysilane and a condensate thereof and a third organic solvent. The liquid (B2) can contain other components in addition to at least one of alkoxysilane and a condensate thereof and the third organic solvent as long as the effects of the present disclosure are not impaired.

In a preferred embodiment, the liquid (B2) consists of at least one of alkoxysilane and a condensate thereof and a third organic solvent. When the liquid (B2) consists of at least one of alkoxysilane and a condensate thereof and a third organic solvent, impurities contained in the third liquid can be reduced as much as possible. As a result, when the silica sol obtained by the production method of the present disclosure is used for a polishing slurry, it is possible to suppress the influence of impurities on polishing. It can be used also for the use applications in which metal impurities are disliked, such as silicon wafers and device wafers, and a polishing slurry which is applicable widely can be provided.

Since the description of the liquid (B2) is the same as that of the liquid (B1) described above, the description thereof is omitted. Since the description of the liquid (C2) is the same as that of the liquid (C1) described above, the description thereof is omitted.

In the growth step, the liquid (B2) or the liquid (B2) and the liquid (C2) are added to and mixed with the second liquid. When the liquid (B2) is mixed with the second liquid, alkoxysilane and the like are hydrolyzed and polycondensed to grow the linked silica core particles included in the second liquid. The growth of the linked silica core particles terminates the addition of the liquid (B2) or the liquid (B2) and the liquid (C2). As a result, the growth of the linked silica core particles can be stopped to prepare the third liquid.

Since the conditions at the time of adding and mixing the liquid (B2) or the liquid (B2) and the liquid (C2) in the second liquid are the same as the conditions at the time of adding and mixing the liquid (B1) or the liquid (B1) and the liquid (C1) in the above-described liquid (A), the description thereof is omitted. The second liquid, the liquid (B2), and the liquid (C2) correspond to the liquid (A), the liquid (B1), and the liquid (C1), respectively.

As described above, the third liquid can be prepared.

In the production method according to the present aspect, the prepared third liquid can be used as a silica sol as it is. A liquid obtained after subjecting the prepared third liquid to a post-processing step and the like described later may be used as a silica sol. In a preferred embodiment, from the viewpoint that aggregation of silica particles can be suppressed, a water substitution step of substituting an organic solvent present in the third liquid with water is performed.

### (Post-Processing Step)

In the method for producing a silica sol of the present disclosure, after performing the bonding step or the growth step described above, a post-processing step described below may be performed.

Specifically, at least one of a water substitution step of substituting an organic solvent present in the second liquid or the third liquid with water and a concentration step of concentrating the second liquid or the third liquid may be performed. More specifically, only the concentration step of concentrating the second liquid or the third liquid may be performed, only the water substitution step of substituting an organic solvent in the second liquid or the third liquid with water may be performed, the water substitution step of substituting an organic solvent in the concentrated liquid with water may be performed after the concentration step, or a concentration step of concentrating the water-substituted liquid may be performed after the water substitution step. The concentration step may be performed a plurality of times, and at that time, the water substitution step may be performed between the concentration step and the concentration step, and for example, after the concentration step, the water substitution step of substituting an organic solvent in the concentrated liquid with water may be performed, and then the concentration step of concentrating the water-substituted liquid may be further performed.

### (Water Substitution Step)

The method for producing a silica sol of the present disclosure may further include, as one embodiment of the present disclosure, a step of substituting an organic solvent contained in the above-described second liquid or third liquid with water (in the present specification, also simply referred to as “water substitution step”). The second liquid or the third liquid of the present aspect also includes an aspect of the second liquid or the third liquid that has undergone the concentration step.

When ammonia is selected as an alkaline catalyst, a pH of the produced silica sol can be adjusted to a neutral region by substituting an organic solvent in the second liquid or the third liquid with water, and a silica sol stable for a long period can be obtained by removing unreacted materials contained in the second liquid or the third liquid.

As a method of substituting an organic solvent in the second liquid or the third liquid with water, a conventionally known method can be used, and examples thereof include a method of substitution by using heating distillation by dropping water while keeping a liquid quantity of the second liquid or the third liquid at a certain level or more. At this time, the substitution operation is preferably continued until liquid temperature and overhead temperature reach the boiling point of water for substitution.

As water to be used in this step, pure water or ultrapure water is preferably used from the viewpoint of minimizing contamination of metal impurities and the like.

Examples of the method of substituting an organic solvent in the second liquid or the third liquid with water include a method of separating silica particles (including linked silica core particles or grown linked silica core particles) by centrifugal separation of the second liquid or the third liquid followed by redispersing the resultant in water.

### (Concentration Step)

The method for producing a silica sol of the present disclosure may further include, as one embodiment of the present disclosure, a step of concentrating the above-described second liquid or third liquid (in the present specification, also simply referred to as “concentration step”). Note that, the second liquid or the third liquid of the present aspect also includes an aspect of the second liquid or the third liquid that has undergone the water substitution step.

The method of concentrating a second liquid or a third liquid is not particularly limited, but a conventionally known method can be used, and examples thereof include a heating concentration method and a membrane concentration method.

In the heating concentration method, the second liquid or the third liquid is heated and concentrated under atmospheric pressure or under reduced pressure, whereby the concentrated second liquid or third liquid can be obtained.

In a membrane concentration method, the second liquid or the third liquid can be concentrated, for example, through membrane separation by an ultrafiltration method in which silica particles (including linked silica core particles or grown linked silica core particles) can be filtered. The molecular weight cut-off of an ultrafiltration membrane is not particularly limited, and the molecular weight cut-off can be selected according to a particle size of produced particles. The material constituting the ultrafiltration membrane is not particularly limited, and examples thereof include polysulfone, polyacrylonitrile, sintered metal, ceramic, and carbon. The form of the ultrafiltration membrane is not particularly limited, and examples thereof include a spiral type, a tubular type, and a hollow fiber type. In the ultrafiltration method, the operation pressure is not particularly limited, and can be set to be equal to or lower than the use pressure of the ultrafiltration membrane to be used.

In the production of the silica sol according to the present aspect, physical properties (average primary particle size, average secondary particle size, average association degree, average aspect ratio, and average circularity) of silica particles in the produced silica sol will be described in a silica sol which is another aspect of the present disclosure described later.

### <Silica Sol>

Another aspect of the present disclosure relates to a silica sol including silica particles having an average aspect ratio of 1.50 or more, in which a ratio of the number of silica particles having an aspect ratio of 1.50 or more to the number of all silica particles is 40% or more. The silica sol according to the present aspect can be used for eliminating the surface roughness since the ratio of the heteromorphized silica particles is large.

The silica sol according to the present aspect can be obtained by the above-described method for producing a silica sol.

In the present specification, the aspect ratio means a value obtained by measuring the value of the long side and the value of the short side of the smallest rectangle circumscribing a silica particle and calculating the ratio of the value of the long side and the value of the short side (the value of the long side/the value of the short side). The average aspect ratio is a value obtained by calculating an average of aspect ratios of a predetermined number (for example, 100 or more) of silica particles. The aspect ratio and the average aspect ratio can be grasped by, for example, scanning electron microscope (SEM) observation. More specifically, as the aspect ratio and the average aspect ratio, values measured by the method described in Examples are adopted.

The ratio of the number of silica particles having an aspect ratio of 1.50 or more to the number of all silica particles can be determined by performing scanning electron microscope (SEM) observation, confirming the aspect ratio of all silica particles (for example, 100 or more) in the SEM image, and calculating the ratio (%) of the number of silica particles having an aspect ratio of 1.50 or more in the SEM image to the number of all silica particles in the SEM image (=the number of silica particles having an aspect ratio of 1.50 or more in the SEM image/the number of all silica particles in the SEM image×100). Details of the measurement method will be described in Examples.

In the silica sol according to the present aspect, the lower limit of the average aspect ratio of the silica particles is 1.50 or more, preferably 1.55 or more, and more preferably 1.60 or more. The upper limit of the average aspect ratio of the silica particles is, for example, 5.00 or less, preferably 4.00 or less, and more preferably 3.00 or less. The average aspect ratio of the silica particles is preferably 1.50 or more and 5.00 or less, more preferably 1.55 or more and 4.00 or less, and still more preferably 1.60 or more and 3.00 or less.

In the silica sol according to the present aspect, the lower limit of the ratio of the number of silica particles having an aspect ratio of 1.50 or more to the number of all silica particles is 40% or more and preferably 50% or more. The upper limit of the ratio of the number of silica particles having an aspect ratio of 1.50 or more to the number of all silica particles is not particularly limited, and may be, for example, 80% or less or 70% or less. The ratio of the number of silica particles having an aspect ratio of 1.50 or more to the number of all silica particles is preferably 40% or more and 80% or less and more preferably 50% or more and 70% or less.

In the silica sol according to the present aspect, the average circularity of the silica particles is preferably 0.80 or less. A preferred embodiment of the present disclosure relates to a silica sol including silica particles having an average aspect ratio of 1.50 or more and an average circularity of 0.80 or less, in which a ratio of the number of silica particles having an aspect ratio of 1.50 or more to the number of all silica particles is 40% or more.

In the present specification, the average circularity means a value obtained by calculating an average of circularities of all silica particles included in the silica sol. As the average circularity, a value measured by the method described in Examples is adopted.

The upper limit of the average circularity of the silica particles is more preferably 0.75 or less and still more preferably 0.70 or less. The lower limit of the average circularity of the silica particles is not particularly limited, and may be, for example, 0.30 or more, 0.40 or more, or 0.50 or more. The average circularity of the silica particles is preferably 0.30 or more and 0.80 or less, more preferably 0.40 or more and 0.75 or less, and still more preferably 0.50 or more and 0.70 or less.

In the silica sol according to the present aspect, a ratio of the number of silica particles having a circularity of 0.90 or more to the number of all silica particles is preferably 40% or less. A preferred embodiment of the present disclosure relates to a silica sol including silica particles having an average aspect ratio of 1.50 or more, in which a ratio of the number of silica particles having an aspect ratio of 1.50 or more to the number of all silica particles is 40% or more, and a ratio of the number of silica particles having a circularity of 0.90 or more to the number of all silica particles is 40% or less. A more preferred embodiment of the present disclosure relates to a silica sol including silica particles having an average aspect ratio of 1.50 or more and an average circularity of 0.80 or less, in which a ratio of the number of silica particles having an aspect ratio of 1.50 or more to the number of all silica particles is 40% or more, and a ratio of the number of silica particles having a circularity of 0.90 or more is 40% or less.

The ratio of the number of silica particles having a circularity of 0.90 or more to the number of all silica particles can be determined by performing scanning electron microscope (SEM) observation, measuring the circularity of each of silica particles in the SEM image, and calculating the ratio (%) of the number of silica particles having a circularity of 0.90 or more in the SEM image to the number of all silica particles (for example, 100 or more) in the SEM image (=the number of silica particles having a circularity of 0.90 or more in the SEM image/the number of all silica particles in the SEM image×100). Details of the measurement method will be described in Examples.

In the silica sol according to the present aspect, the upper limit of the ratio of the number of silica particles having a circularity of 0.90 or more to the number of all silica particles is more preferably 30% or less. The lower limit of the ratio of the number of silica particles having a circularity of 0.90 or more to the number of all silica particles is not particularly limited, and may be, for example, 5% or more or 10% or more. The ratio of the number of silica particles having a circularity of 0.90 or more to the number of all silica particles is preferably 5% or more and 40% or less and more preferably 10% or more and 30% or less.

In the silica sol according to the present aspect, the average primary particle size of the silica particles is, for example, 5 nm or more and 40 nm or less and preferably 10 nm or more and 30 nm or less. The average primary particle size of the silica particles can be calculated based on, for example, the specific surface area (SA) of the silica particles calculated by the BET method and the density of the silica particles. More specifically, as the average primary particle size of the silica particles, a value measured by the method described in Examples is adopted.

In the silica sol according to the present aspect, the average secondary particle size of the silica particles is, for example, 30 nm or more and 70 nm or less and preferably 40 nm or more and 60 nm or less. The average secondary particle size of the silica particles can be measured by, for example, a dynamic light scattering method represented by a laser diffraction scattering method. More specifically, as the average secondary particle size of the silica particles, a value measured by the method described in Examples is adopted.

In the silica sol according to the present aspect, the average association degree (the ratio of the average secondary particle size to the average primary particle size) of the silica particles is, for example, 1.7 or more, preferably 1.8 or more and 5.5 or less, more preferably 2.0 or more and 5.0 or less, and still more preferably 2.2 or more and 4.5 or less.

The pH of the silica sol according to the present aspect is not particularly limited as long as gelation does not occur. For example, the pH of the silica sol obtained by the above-described production method may be 5.0 or more and 8.0 or less or 6.5 or more and 7.5 or less. The pH of the silica sol can be measured with a pH meter.

In the silica sol according to the present aspect, the concentration (content) of the silica particles can be appropriately adjusted within a range in which gelation does not occur. The method for adjusting the concentration of the silica particles is not particularly limited, and examples thereof include a method of diluting the silica particles with water and a method of performing the concentration step.

The silica sol according to the present aspect may contain water. The concentration (content) of water in the silica sol is not particularly limited, and can be appropriately adjusted according to the concentration (content) of the silica particles.

Examples of components other than water that can be contained in the silica sol include components derived from the above-described production process. Examples of the components other than water include an alkaline catalyst, an organic solvent, alkoxysilane and a condensate thereof, and metal impurities. Components other than silica particles and water are preferably removed as much as possible. The content of the components other than silica particles and water in the silica sol is preferably 0.0001 mass % or less and more preferably 0 mass %.

### <Use Application>

The silica sol according to the present aspect can be used in various use applications. In particular, it can be suitably used as abrasive grains for polishing an object to be polished such as a semiconductor substrate. Examples of the object to be polished include metals or semimetals such as silicon materials, aluminum, nickel, tungsten, steel, tantalum, titanium, and stainless steel, or alloys thereof, glassy materials such as quartz glass, aluminosilicate glass, and glassy carbon; ceramic materials such as alumina, silica, sapphire, silicon nitride, tantalum nitride, and titanium carbide; compound semiconductor substrate materials such as silicon carbide, gallium nitride, and gallium arsenide; and resin materials such as polyimide resin. The silica sol produced by the production method of the present disclosure can be used for filler for resin (for example, filler for encapsulation of semiconductor elements), hard coating agents, resin modifiers, surface treatment agents, paints, pigments, catalysts, antislipping agents, spacers of liquid crystal display devices, fiber processing agents, binders, adhesives, polymer flocculants, toners, cleaning agents, cosmetics, dental materials, nanocomposites, thermosensitive recording materials, photosensitive films, precipitating agents, and the like.

The present disclosure includes the following aspects and embodiments.

[1] A method for producing a silica sol, including:
preparing a first liquid including silica core particles having an average value of longest diameters of primary particles of 20 nm or less; and
preparing a second liquid including linked silica core particles by holding the first liquid for 72 hours or longer.

[2] The method for producing a silica sol according to [1], wherein in the preparing the first liquid, a liquid (B1) containing at least one of alkoxysilane and a condensate thereof and a second organic solvent or the liquid (B1) and a liquid (C1) containing water and being free of an alkaline catalyst are added to and mixed with a liquid (A) containing an alkaline catalyst, water, and a first organic solvent, and the addition is terminated to prepare the first liquid when the average value of longest diameters of primary particles of the silica core particles is 20 nm or less.

[3] The method for producing a silica sol according to [2], wherein the alkaline catalyst is ammonia.

[4] The method for producing a silica sol according to [2] or [3], wherein the first organic solvent and the second organic solvent are methanol.

[5] The method for producing a silica sol according to any one of [1] to [4], further including preparing a third liquid including the grown linked silica core particles by adding and mixing a liquid (B2) containing at least one of alkoxysilane and a condensate thereof and a third organic solvent or the liquid (B2) and a liquid (C2) containing water and being free of an alkaline catalyst to the second liquid, after the preparing the first liquid.

[6] A silica sol including silica particles having an average aspect ratio of 1.50 or more, wherein a ratio of the number of silica particles having an aspect ratio of 1.50 or more to the number of all silica particles is 40% or more.

[7] The silica sol according to [6], wherein an average circularity of the silica particles is 0.80 or less.

[8] The silica sol according to [6] or [7], wherein a ratio of the number of silica particles having a circularity of 0.90 or more to the number of all silica particles is 40% or less.

### EXAMPLES

The present disclosure will be described in more detail with the following Examples and Comparative Examples. However, the technical scope of the present disclosure is not limited only to the following Examples. Unless otherwise specified, “%” and “part(s)” mean “% by mass” and “part(s) by mass”. In the following Examples, unless otherwise specified, the operation was performed under the conditions of room temperature (20 to 25° C.)/relative humidity of 40 to 50% RH.

### Example 1

### (Silica Core Particle Preparation Step)

Into a 5 L reaction container with a stirrer having a cooling function, a liquid (A) prepared by mixing 335 g of pure water and 359 g of 29 mass % ammonia water with 3266 g of methanol (manufactured by KANTO CHEMICAL CO., INC.) was added, the liquid temperature (reaction liquid temperature) in the reaction container was maintained at 55° C., a liquid (B1) prepared by dissolving 88 g of tetramethoxysilane (TMOS, manufactured by TAMA CHEMICALS CO., LTD.) in 22 g of methanol and a liquid (C1) of 21 g of pure water were simultaneously added with stirring at 300 rpm to prepare a reaction liquid, and a synthesis reaction was allowed to proceed.

The addition rate of the liquid (B1) was 1.2×10⁻³ mol/min in terms of silicon atoms with respect to 1 mol of water contained in the liquid (A). The liquid (C1) was added so as to be 2 mol/min in terms of water with respect to 1 mol (in terms of silicon atoms) of tetramethoxysilane to be charged in the liquid (B1).

When the average value of longest diameters of primary particles of the synthesized silica core particles reached 17.8 nm, the addition of the liquid (B1) and the liquid (C1) was terminated to complete the synthesis reaction, thereby preparing a first liquid.

### (Bonding Step)

The prepared first liquid was held in the same reaction container under stirring at a rotation speed of 300 rpm. The liquid temperature when the holding was started was 55° C. and then was maintained at room temperature, and the temperature when the holding was completed was 25° C. The stirring was terminated 136 hours after the completion of the addition of the liquid (B1) and the liquid (C1) to prepare a second liquid.

### (Growth Step)

Into a 5 L reaction container with a stirrer having a cooling function, 3570 g of the prepared second liquid was added, the liquid temperature in the reaction container was maintained at 55° C., a liquid (B2) prepared by dissolving 324 g of tetramethoxysilane (TMOS) in 83 g of methanol and a liquid (C2) of 77 g of pure water were simultaneously added with stirring at 300 rpm to prepare a third liquid.

The addition rate of the liquid (B2) was 1.2×10⁻³ mol/min in terms of silicon atoms with respect to 1 mol of water contained in the second liquid. The liquid (C2) was added so as to be 2 mol/min in terms of water with respect to 1 mol (in terms of silicon atoms) of tetramethoxysilane to be charged in the liquid (B2).

### (Water Substitution Step)

The obtained third liquid was heated under atmospheric pressure at a temperature where the third liquid turned into a boiling state. When heating was performed, pure water was added while the liquid surface was kept constant, and heating distillation was performed to substitute methanol in the reaction liquid with pure water, thereby obtaining a silica sol.

### Example 2

### (Silica Core Particle Preparation Step and Bonding Step)

A second liquid was prepared in the same manner as in Example 1.

### (Growth Step)

Into a 5 L reaction container with a stirrer having a cooling function, 4016 g of the prepared second liquid was added, the liquid temperature in the reaction container was maintained at 55° C., a liquid (B2) prepared by dissolving 127 g of tetramethoxysilane (TMOS) in 33 g of methanol and a liquid (C2) of 30 g of pure water were simultaneously added with stirring at 300 rpm to prepare a third liquid.

The addition rate of the liquid (B2) was 1.2×10⁻³ mol/min in terms of silicon atoms with respect to 1 mol of water contained in the second liquid. The liquid (C2) was added so as to be 2 mol/min in terms of water with respect to 1 mol (in terms of silicon atoms) of tetramethoxysilane to be charged in the liquid (B2).

### (Water Substitution Step)

The obtained third liquid was heated under atmospheric pressure at a temperature where the third liquid turned into a boiling state. When heating was performed, pure water was added while the liquid surface was kept constant, and heating distillation was performed to substitute methanol in the reaction liquid with pure water, thereby obtaining a silica sol.

### Example 3

### (Silica Core Particle Preparation Step)

Into a 5 L reaction container with a stirrer having a cooling function, a liquid (A) prepared by mixing 335 g of pure water and 359 g of 29 mass % ammonia water with 3266 g of methanol (manufactured by KANTO CHEMICAL CO., INC.) was added, the liquid temperature (reaction liquid temperature) in the reaction container was maintained at 55° C., a liquid (B1) prepared by dissolving 88 g of tetramethoxysilane (TMOS, manufactured by TAMA CHEMICALS CO., LTD.) in 22 g of methanol was added with stirring at 300 rpm to prepare a reaction liquid, and a synthesis reaction was allowed to proceed.

The addition rate of the liquid (B1) was 1.2×10⁻³ mol/min in terms of silicon atoms with respect to 1 mol of water contained in the liquid (A).

When the average value of longest diameters of primary particles of the synthesized silica core particles reached 17.8 nm, the addition of the liquid (B1) was terminated to prepare a first liquid.

### (Bonding Step)

The prepared first liquid was held in the same reaction container under stirring at a rotation speed of 300 rpm. The liquid temperature when the holding was started was 55° C. and then was maintained at room temperature, and the temperature when the holding was completed was 25° C. The stirring was terminated 110 hours after the completion of the addition of the liquid (B1) to prepare a second liquid.

### (Water Substitution Step)

The obtained second liquid was heated under atmospheric pressure at a temperature where the second liquid turned into a boiling state. When heating was performed, pure water was added while the liquid surface was kept constant, and heating distillation was performed to substitute methanol in the reaction liquid with pure water, thereby obtaining a silica sol.

### Example 4

### (Silica Core Particle Preparation Step)

A first liquid was prepared in the same manner as in Example 1.

### (Bonding Step)

The prepared first liquid was held in the same reaction container under stirring at a rotation speed of 300 rpm. The liquid temperature when the holding was started was 55° C. and then was maintained at room temperature, and the temperature when the holding was completed was 25° C. The stirring was terminated 72 hours after the completion of the addition of the liquid (B1) and the liquid (C1) to prepare a second liquid.

### (Water Substitution Step)

The obtained second liquid was heated under atmospheric pressure at a temperature where the second liquid turned into a boiling state. When heating was performed, pure water was added while the liquid surface was kept constant, and heating distillation was performed to substitute methanol in the reaction liquid with pure water, thereby obtaining a silica sol.

### Comparative Example 1

Into a 5 L reaction container with a stirrer having a cooling function, a liquid (A′) prepared by mixing 375.92 g of pure water, 108 g of 29 mass % ammonia water, and 91 g of colloidal silica (silica concentration: 12 mass %, average secondary particle size: 25 nm, average value of longest diameters of primary particles: 18.9 nm) with 2945 g of methanol was added, the liquid temperature in the reaction container was maintained at 20° C., and a liquid (B′) prepared by dissolving 309 g of tetramethoxysilane (TMOS) in 79 g of methanol was added with stirring at 300 rpm to prepare a reaction liquid.

The addition rate of the liquid (B′) was 1.9×10⁻³ mol/min in terms of silicon atoms with respect to 1 mol of water contained in the liquid (A′).

The obtained reaction liquid was heated under atmospheric pressure at a temperature where the reaction liquid turned into a boiling state. When heating was performed, pure water was added while the liquid surface was kept constant, and heating distillation was performed to substitute methanol in the reaction liquid with pure water, thereby obtaining a silica sol.

### Comparative Example 2

Into a 5 L reaction container with a stirrer having a cooling function, a liquid (A′) prepared by mixing 411.36 g of pure water, 108 g of 29 mass % ammonia water, and 46.5 g of colloidal silica (silica concentration: 4 mass %, average secondary particle size: 8 nm, average value of longest diameters of primary particles: 8 nm or less) with 2945 g of methanol was added, the liquid temperature in the reaction container was maintained at 20° C., and a liquid (B′) prepared by dissolving 309 g of tetramethoxysilane (TMOS) in 79 g of methanol was added with stirring at 300 rpm to prepare a reaction liquid.

The addition rate of the liquid (B′) was 1.3×10⁻⁴ mol/min in terms of silicon atoms with respect to 1 mol of water contained in the liquid (A′).

The obtained reaction liquid was heated under atmospheric pressure at a temperature where the reaction liquid turned into a boiling state. When heating was performed, pure water was added while the liquid surface was kept constant, and heating distillation was performed to substitute methanol in the reaction liquid with pure water, thereby obtaining a silica sol.

### Comparative Example 3

Into a 5 L reaction container with a stirrer having a cooling function, a liquid (A) prepared by mixing 167 g of pure water and 180 g of 29 mass % ammonia water with 1633 g of methanol was added, the liquid temperature in the reaction container was maintained at 55° C., a liquid (B1) prepared by dissolving 88 g of tetramethoxysilane (TMOS) in 22 g of methanol was added with stirring at 300 rpm to prepare a reaction liquid, and a synthesis reaction was allowed to proceed.

The addition rate of the liquid (B1) was 1.2×10⁻³ mol/min in terms of silicon atoms with respect to 1 mol of water contained in the liquid (A).

When the average value of longest diameters of primary particles of the synthesized silica core particles reached 19.7 nm, the addition of the liquid (B1) was terminated to prepare a first liquid.

The obtained first liquid was heated under atmospheric pressure at a temperature where the first liquid turned into a boiling state. When heating was performed, pure water was added while the liquid surface was kept constant, and heating distillation was performed to substitute methanol in the reaction liquid with pure water, thereby obtaining a silica sol.

### Comparative Example 4

Into a 5 L reaction container with a stirrer having a cooling function, a liquid (A) prepared by mixing 167 g of pure water and 180 g of 29 mass % ammonia water with 1633 g of methanol was added, the liquid temperature in the reaction container was maintained at 55° C., a liquid (B1) prepared by dissolving 175 g of tetramethoxysilane (TMOS) in 45 g of methanol was added with stirring at 300 rpm to prepare a reaction liquid, and a synthesis reaction was allowed to proceed.

The addition rate of the liquid (B1) was 1.2×10⁻³ mol/min in terms of silicon atoms with respect to 1 mol of water contained in the liquid (A).

When the average value of longest diameters of primary particles of the synthesized silica core particles reached 23.0 nm, the addition of the liquid (B1) was terminated to prepare a first liquid.

The prepared first liquid was held in the same reaction container under stirring at a rotation speed of 300 rpm. The liquid temperature when the holding was started was 55° C. and then was maintained at room temperature, and the temperature when the holding was completed was 25° C. The stirring was terminated 264 hours after the completion of the addition of the liquid (B1) to prepare a silica particle-containing liquid.

The obtained silica particle-containing liquid was heated under atmospheric pressure at a temperature where the silica particle-containing liquid turned into a boiling state. When heating was performed, pure water was added while the liquid surface was kept constant, and heating distillation was performed to substitute methanol in the reaction liquid with pure water, thereby obtaining a silica sol.

In the method for producing a silica sol according to Examples 1 to 4 and Comparative Examples 1 to 4, the amount of raw materials used and the conditions are summarized in Tables 1 and 2.

TABLE 1

| | Silica core particle preparation step | | | | | | | | | |
|---|---|---|---|---|---|---|---|---|---|---|
| | | | | | | Liquid | | | | |
| | | | | | | (C1) | Addition | | Length | Bonding |
| | Liquid (A1) [g] | | | | | [g] | rate*¹ | Reaction | of core | step |
| | | | Pure | Liquid (B1) [g] | | Pure | [mol/ | temperature | particle*² | Time |
| | Methanol | Ammonia*³ | water | TMOS | Methanol | water | min] | [° C.] | [nm] | [h] |
| Example 1 | 3266 | 359 | 335 | 88 | 22 | 21 | 1.2 × 10⁻³ | 55 | 17.8 | 136 |
| Example 2 | 3266 | 359 | 335 | 88 | 22 | 21 | 1.2 × 10⁻³ | 55 | 17.8 | 136 |
| Example 3 | 3266 | 359 | 335 | 88 | 22 | 0 | 1.2 × 10⁻³ | 55 | 17.8 | 110 |
| Example 4 | 3266 | 359 | 335 | 88 | 22 | 21 | 1.2 × 10⁻³ | 55 | 17.8 | 72 |
| Com- | Not performed | | | | | | | | | Not |
| parative | | | | | | | | | | performed |
| Example 1 | | | | | | | | | | |
| Com- | Not performed | | | | | | | | | Not |
| parative | | | | | | | | | | performed |
| Example 2 | | | | | | | | | | |
| Com- | 1633 | 180 | 167 | 88 | 22 | 0 | 1.2 × 10⁻³ | 55 | 19.7 | Not |
| parative | | | | | | | | | | performed |
| Example 3 | | | | | | | | | | |
| Com- | 1633 | 180 | 167 | 175 | 45 | 0 | 1.2 × 10⁻³ | 55 | 23.0 | 264 |
| parative | | | | | | | | | | |
| Example 4 | | | | | | | | | | |

*¹: Addition rate (in terms of silicon atoms) of the liquid (B1) with respect to 1 mol of water contained in the liquid (A)
*²: Average value of longest diameters of primary particles of silica core particles
*³: Amount of 29 mass % ammonia water

TABLE 2

| | Growth step | | | | | | | | | |
|---|---|---|---|---|---|---|---|---|---|---|
| | | | | | | | | Liquid | | |
| | | | | | | | | (C2) | Addition | |
| | Second | Liquid (A′) [g] | | | | | | [g] | rate*¹ | Reaction |
| | liquid | | | Pure | Colloidal | Liquid (B2) [g] | | Pure | [mol/ | temperature |
| | [g] | Methanol | Ammonia*² | water | silica | TMOS | Methanol | water | min] | [° C.] |
| Example 1 | 3570 | — | — | — | — | 324 | 83 | 77 | 1.2 × 10⁻³ | 55 |
| Example 2 | 4016 | — | — | — | — | 127 | 33 | 30 | 1.2 × 10⁻³ | 55 |
| Example 3 | Not performed | | | | | | | | | |
| Example 4 | Not performed | | | | | | | | | |
| Com- | — | 2945 | 108 | 375.92 | 91 | 309 | 79 | 0 | 1.9 × 10⁻³ | 20 |
| parative | | | | | | | | | | |
| Example 1 | | | | | | | | | | |
| Com- | — | 2945 | 108 | 411.36 | 46.5 | 309 | 79 | 0 | 1.3 × 10⁻³ | 20 |
| parative | | | | | | | | | | |
| Example 2 | | | | | | | | | | |
| Com- | Not performed | | | | | | | | | |
| parative | | | | | | | | | | |
| Example 3 | | | | | | | | | | |
| Com- | Not performed | | | | | | | | | |
| parative | | | | | | | | | | |
| Example 4 | | | | | | | | | | |

*¹: Addition rate (in terms of silicon atoms) of the liquid (B2) with respect to 1 mol of water contained in the second liquid or the liquid (A′)
*²: Amount of 29 mass % ammonia water

### [Measurement Methods of Various Physical Properties]

In Examples and Comparative Examples, various physical properties were measured by the following methods. The results are shown in Table 3.

### <Scanning Electron Microscope (SEM) Image>

SEM images of the silica particles in the silica sols of Examples 1 to 4 and Comparative Examples 1 to 4 and the silica core particles in the reaction liquids of Examples 1 to 4 and Comparative Examples 3 and 4 were taken using a scanning electron microscope (SEM) SU8000 (manufactured by Hitachi High-Technologies Corporation) at a magnification at which the number of particles was 100 or more and 1000 or less.

### <Average Value of Longest Diameters of Primary Particles of Silica Core Particles>

In Examples 1 to 4 and Comparative Examples 3 and 4, the longest diameters of primary particles of each silica core particle was measured for all silica core particles in the captured SEM image as exemplified by double-headed arrows in FIG. 1, and the average value of longest diameters of primary particles of all silica core particles was calculated.

### <Average Primary Particle Size>

The value of the average primary particle size of silica particles in the silica sols of Examples 1 to 4 and Comparative Examples 1 to 4 was calculated by the formula of primary particle size=6000/(SA×2.2) based on the specific surface area (SA) of the silica particles measured by a BET method using a fully automatic specific surface area measuring apparatus Macsorb (registered trademark) HM Model-1201 (manufactured by Mountech Co., Ltd.), with the true specific gravity of silica being 2.2 g/cm³.

### <Average Secondary Particle Size>

As the value of the average secondary particle size of the silica particles in the silica sols of Examples 1 to 4 and Comparative Examples 1 to 4, a value measured as a volume average particle size by a dynamic light scattering method using a particle size distribution measuring apparatus (UPA-UT151, manufactured by Nikkiso Co., Ltd.) was adopted.

### <Average Association Degree>

The average association degree was calculated by dividing the average primary particle size from the average secondary particle size.

### <Average Value of Aspect Ratios>

For the silica particles in the silica sols of Examples 1 to 4 and Comparative Examples 1 to 4, the value of the long side and the value of the short side of the smallest rectangle circumscribing each silica particle in the captured SEM image were measured, the ratio of the value of the long side and the value of the short side thus calculated (the value of the long side/the value of the short side) was taken as the aspect ratio, and the average value of aspect ratios of all silica particles in the captured SEM image was calculated.

### <Ratio of Number of Silica Particles Having Aspect Ratio of 1.50 or More to Number of All Silica Particles>

For the silica particles in the silica sols of Examples 1 to 4 and Comparative Examples 1 to 4, the value of the long side and the value of the short side of the smallest rectangle circumscribing each silica particle in the captured SEM image were measured, and the ratio of the value of the long side and the value of the short side thus calculated (the value of the long side/the value of the short side) was taken as the aspect ratio. The ratio (%) of the number of silica particles having an aspect ratio of 1.50 or more in the SEM image to the number of all silica particles in the SEM image (=the number of silica particles having an aspect ratio of 1.50 or more in the SEM image/the number of all silica particles in the SEM image×100) was calculated.

### <Average Value of Circularities>

For the silica particles in the silica sols of Examples 1 to 4 and Comparative Examples 1 to 4, the circularity of each silica particle in the captured SEM image was measured, and the average value of circularities of all silica particles in the captured SEM image was calculated. The circularity was calculated from the following formula by obtaining the area(S) and the perimeter (L) of silica particles.

Circularity=4πS/L² (S=circle area, L=perimeter)

### <Ratio of Number of Silica Particles Having Circularity of 0.90 or More to Number of All Silica Particles>

For the silica particles in the silica sols of Examples 1 to 4 and Comparative Examples 1 to 4, the circularity of each silica particle in the captured SEM image was measured. The ratio (%) of the number of silica particles having a circularity of 0.90 or more in the SEM image to the number of all silica particles in the SEM image (=the number of silica particles having a circularity of 0.90 or more in the SEM image/the number of all silica particles in the SEM image×100) was calculated.

TABLE 3

| | Silica particles in silica sol | | | | | | |
|---|---|---|---|---|---|---|---|
| | Average | Average | | Aspect ratio | | Circularity | |
| | primary | secondary | Average | | Ratio of | | Ratio of |
| | particle size | particle size | association | Average | 1.50 | Average | 0.90 |
| | [nm] | [nm] | degree | value | or more*¹ | value | or more*² |
| Example 1 | 24 | 58 | 2.4 | 1.66 | 59% | 0.68 | 21% |
| Example 2 | 17 | 51 | 3.0 | 1.75 | 64% | 0.62 | 19% |
| Example 3 | 12 | 51 | 4.3 | 1.77 | 63% | 0.56 | 18% |
| Example 4 | 12 | 44 | 3.7 | 1.64 | 54% | 0.68 | 28% |
| Comparative | 34 | 103 | 3.0 | 1.42 | 18% | 0.87 | 53% |
| Example 1 | | | | | | | |
| Comparative | 13 | 19 | 1.5 | 1.37 | 28% | 0.86 | 52% |
| Example 2 | | | | | | | |
| Comparative | 13 | 21 | 1.6 | 1.19 | 8% | 0.96 | 88% |
| Example 3 | | | | | | | |
| Comparative | 19 | 26 | 1.4 | 1.28 | 21% | 0.92 | 75% |
| Example 4 | | | | | | | |

*¹: Ratio of the number of silica particles having an aspect ratio of 1.50 or more to the number of all silica particles
*²: Ratio of the number of silica particles having a circularity of 0.90 or more to the number of all silica particles

As shown in Table 3, it can be seen that the silica particles in the silica sols of Examples 1 to 4 have a high association degree, a high average aspect ratio, and a low circularity as compared with Comparative Examples 1 to 4. In the silica sols of Examples 1 to 4, since the number of silica particles having an aspect ratio of 1.50 or more with respect to the number of all silica particles is 40% or more, and the number of silica particles having a circularity calculated based on an image observed with a scanning electron microscope of 0.90 or more is 40% or less, it can be seen that the silica sols of Examples 1 to 4 contain many heteromorphized silica particles.

The present application is based on Japanese Patent Application No. 2024-055421 filed on Mar. 29, 2024, the disclosure content of which is incorporated herein by reference in its entirety.

What is claimed is:

1. A method for producing a silica sol, comprising:
preparing a first liquid including silica core particles having an average value of longest diameters of primary particles of 20 nm or less; and
preparing a second liquid including linked silica core particles by holding the first liquid for 72 hours or longer.

2. The method for producing a silica sol according to claim 1, wherein in the preparing the first liquid, a liquid (B1) containing at least one of alkoxysilane and a condensate thereof and a second organic solvent or the liquid (B1) and a liquid (C1) containing water and being free of an alkaline catalyst are added to and mixed with a liquid (A) containing an alkaline catalyst, water, and a first organic solvent, and the addition is terminated to prepare the first liquid when the average value of longest diameters of primary particles of the silica core particles is 20 nm or less.

3. The method for producing a silica sol according to claim 2, wherein the alkaline catalyst is ammonia.

4. The method for producing a silica sol according to claim 2, wherein the first organic solvent and the second organic solvent are methanol.

5. The method for producing a silica sol according to claim 1, further comprising preparing a third liquid including the grown linked silica core particles by adding and mixing a liquid (B2) containing at least one of alkoxysilane and a condensate thereof and a third organic solvent or the liquid (B2) and a liquid (C2) containing water and being free of an alkaline catalyst to the second liquid, after the preparing the first liquid.

6. A silica sol comprising silica particles having an average aspect ratio of 1.50 or more,
wherein a ratio of the number of silica particles having an aspect ratio of 1.50 or more to the number of all silica particles is 40% or more.

7. The silica sol according to claim 6, wherein an average circularity of the silica particles is 0.80 or less.

8. The silica sol according to claim 6, wherein a ratio of the number of silica particles having a circularity of 0.90 or more to the number of all silica particles is 40% or less.
